(19) United States
(12) Patent Application Publication
(10) Pub. No.: US 2025/0307433 A1
(43) Pub. Date: Oct. 2, 2025

(54) EMERGING MIND

(71) Applicant: Carl WIMMER, Guadalajara (MX)

(72) Inventors: Graham CLARK, Kings Lynn (GB); Eric William HEY, Dauis, Bohol (PH); Anthony MANNELLA, Niagara Falls (CA); Carl WIMMER, Guadalajara (MX)

(21) Appl. No.: 18/855,090

(22) PCT Filed: Apr. 11, 2023
(86) PCT No.: PCT/IB2023/053649

§ 371 Date: Oct. 8, 2024

Related U.S. Application Data
(60) Provisional application No. 63/330,648, filed on Apr. 13, 2022.

(51) Int. Cl. G06F 21/60

(52) U.S. Cl. CPC G06F 21/602

(57) ABSTRACT

A computing device, a computer-readable medium, and a method are provided. First information, including a topic that a user was working on at a user computing device are received by a hub. The hub scavenges available databases for second information related to the topic and provides the second information to the user computing device for inclusion in a user's frame of reference. In another embodiment, first information including one or more topics that a user was working on is provided to a hub from a user's computing device. The user's computing device receives second information from the hub, the second information being related to the first information. The user's computing device includes the second information in a user's frame of reference, which includes the one or more topics of interest to the user, and one or more references to content associated with the one or more topics of interest.

### CROSS REFERENCE TO RELATED APPLICATIONS

This application is the U.S. national phase of PCT Application No. PCT/IB2023/053649, filed in the International Bureau on Apr. 11, 2023, which claims the benefit of U.S. Provisional Patent Application No. 63/330,648, filed in the U.S. Patent and Trademark Office on Apr. 13, 2022.

This application is related to PCT Patent Application No. PCT/IB2021/060629, filed Nov. 17, 2021, and U.S. Provisional Patent Application No. 63/225,725, filed Jul. 26, 2021.

### BACKGROUND

A number of tools have been developed to aid users to search for and quickly understand digital textual documents. One such tool is a comprehension engine, which is described in PCT application PCT/IB2021/060629, filed at the receiving office of the International Bureau on Nov. 17, 2021. Another such tool that aids users in comprehending digital documents is a foci analysis tool, which is described in U.S. Provisional Patent Application No. 63/225,725, filed in the U.S. Patent and Trademark Office on Jul. 26, 2021.

### SUMMARY

In a first aspect of embodiments, a computing device is provided. The computing device includes at least one processor, a first main memory, and a first communication interface. The first communication interface and the first main memory are connected to the at least one first processor via a first bus. The first main memory includes instructions for configuring the at least one processor to create a record log on the computing device upon creation of a document on the computing device. The record log includes a name of a user who created the document and a start time indicating a time and a date of creation of the document. Upon completion of the document, a first hash of the completed document is calculated and stored to the record log, a second hash of contents of the record log is calculated, and the second hash is provided for storage to a blockchain residing in a hub on a different computing device.

In a second aspect of embodiments, a computer-readable medium is provided that has stored thereon instructions for a processor of a computing device. The instructions configure the processor to perform a method. According to the method, first information is received from a user computing device. The first information includes a topic that a user was working on at the user computing device. Available databases are scavenged for second information related to the topic. The second information is provided to the user computing device for inclusion in a frame of reference of the user.

In a third aspect of embodiments, a machine-implemented method on a user computing device connected to a hub executing on a second computing device is provided. According to the method, first information including one or more topics that a user was working on at the user computing device is provided to the hub. Second information is received from the hub, wherein at least some of the second information is related to the first information provided to the hub. The second information is included in a frame of reference of the user. The frame of reference includes one or more topics of interest to the user and one or more references to content associated with the one or more topics of interest.

### BRIEF DESCRIPTION OF THE DRAWINGS

FIG. 1 provides an example implementation of a user interface for use with a comprehension engine.

FIG. 2 shows an example result list for documents returned based on a search query of FIG. 1.

FIG. 3 provides an example of a decomposition function that decomposes a document resource into knowledge fragments.

FIG. 4 shows an example payload of knowledge fragments based on the knowledge fragments produced by the decomposition function decomposing a document resource.

FIG. 5 provides an example of a sorting analysis visualization (SAV) function that may include multiple SAV presets, each of which may define how a payload is to be analyzed, sorted, and presented.

FIG. 6 illustrates an example process in which a user may comment on a sorted, analyzed, and visualized payload to thereby form a new interpretation of the payload.

FIG. 7 shows an example visual presentation of N sentences included in a document to be analyzed.

FIG. 8 provides an example of a document being divided into a number of windows such that each following window includes overlaps with some sentences of an immediately preceding window.

FIG. 9 shows first relata, represented as small circles, in some of the windows.

FIG. 10 is an example display showing a first relatum, O, which is a central prime focus, having direct and indirect relations with other relata.

FIG. 11 illustrates example export functions that may be implemented in embodiments of the comprehension engine.

FIG. 12 is a flowchart of a process that may be performed by a comprehension engine to comprehend selected documents.

FIG. 13 is an example flow diagram showing outputs from process blocks of FIG. 12 being input to other process blocks of FIG. 12 and output from some of the process blocks being used to generate new keywords that may be used as query terms in process block 1210 of FIG. 12.

FIG. 14 illustrates an example environment in which implementations of a foci analysis tool may operate.

FIG. 15 shows an example environment in which embodiments of an emerging mind may operate.

FIG. 16 illustrates an example user profile that may be stored on a user's computing device in embodiments of the emerging mind.

FIG. 17 is a flowchart of an example process that may be performed when a user attempts to connect to a hub in embodiments of the emerging mind.

FIGS. 18 and 19 illustrate two examples of how a user's computing device may be connected with one or more HUBs in various embodiments of the emerging mind.

FIG. 20 illustrates a number of example paths through which knowledge may grow, from a user's point of view, in a network of connected hubs and user computing devices in embodiments of the emerging mind.

FIG. 21 shows an example user frame of reference, which may store information related to one or more topics of interest of the user for the user to access in embodiments of the emerging mind.

FIG. 22 illustrates a record log being created when a document is created, calculating and storing of a first hash of the completed document in the record log, and calculating and storing of a second hash of the record log in a blockchain residing in a hub according to embodiments of the emerging mind.

FIG. 23 shows an example dashboard at a HUB level through which an administrator or an information officer may monitor knowledge creation and generation as well as knowledge dissemination related to a HUB according to embodiments of the emerging mind.

FIG. 24 illustrates an example computing device that may be used to implement a user's computing device or a HUB according to embodiments of the emerging mind, as well as an example computing device that may be used to implement embodiments of a comprehension engine or a foci analysis tool.

### DETAILED DESCRIPTION

Various embodiments of the emerging mind may work cooperatively with other tools for generating knowledge from electronic textual documents such as, for example, a comprehension engine and/or a foci analysis tool.

### Comprehension Engine

Search engines may effectively find and rank documents in order of pertinence based on one or more query terms input by a user. However, search engines lack an ability to comprehend contents of query results. Aspects of the comprehension engine provide automated knowledge generation. The comprehension engine extends capabilities of search engines by analyzing a knowledge payload and assisting in sorting, analysis and visualization of contents from a selected document. In some embodiments, a selected document may be identified from a search engine in response to a search query that includes one or more query terms, but may also be uploaded to the comprehension engine independently of a search engine.

In some embodiments, aspects of the comprehension engine may decompose one or more selected document by processing the selected document and returning a JSON object with notes (also referred to as a knowledge fragment). Some aspects of the comprehension engine may be incorporated into a web browser having available source code. In some embodiments the comprehension engine may be incorporated into a word processor and/or a software tool. Some embodiments may include a link to a composer as well as tabs for different varieties of sorting, analysis and visualization (“SAV”) techniques. In addition, the final comprehension engine output may be exported in a variety of formats (e.g., print, saved/stored as a file, posted to social media, email, etc.).

Embodiments of the comprehension engine may include a system, method, and/or a non-transitory computer-readable storage medium at any possible technical detail level of integration. The non-transitory computer-readable storage medium (or media) has computer readable program instructions stored thereon for causing a processor to carry out aspects of the comprehension engine.

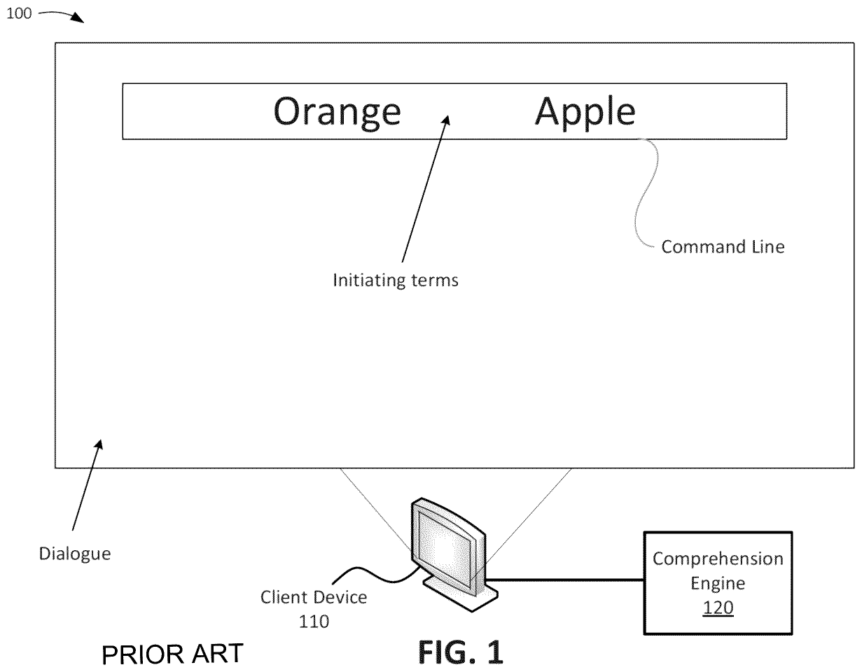

FIG. 1 illustrates an overview of an example implementation of the comprehension engine in accordance with aspects of the present disclosure. As shown in FIG. 1, a client device 110 (e.g., a desktop, computing device, portable computing device, tablet, smart phone, etc.) may present a user interface 100 (e.g., within an application or browser hosted by the client device 110). In some embodiments, the interface 100 may include a command line within a dialog box in which a user may input initiating search query terms (e.g., “orange” and “apple”). As further shown in FIG. 1, the client device 110 may communicate with a comprehension engine 120 which may execute one or more processes consistent with aspects of the comprehension engine based on user inputs received by the client device 110.

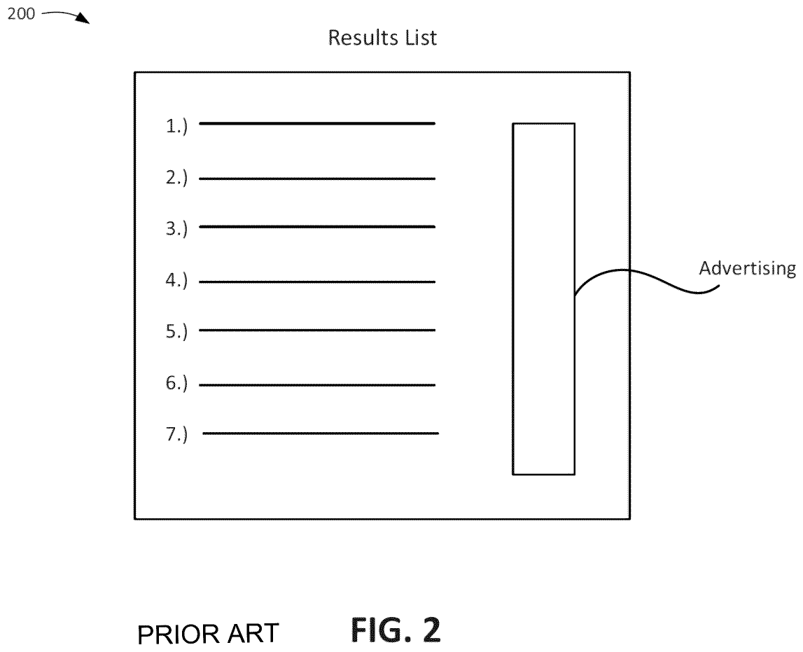

FIG. 2 illustrates an example results list of documents returned based on the search query terms from FIG. 1. The results list may be presented in a user interface 200 as shown, and the user may select one or more documents from the results list. As further shown in FIG. 2, the results list may include a section to present advertising content.

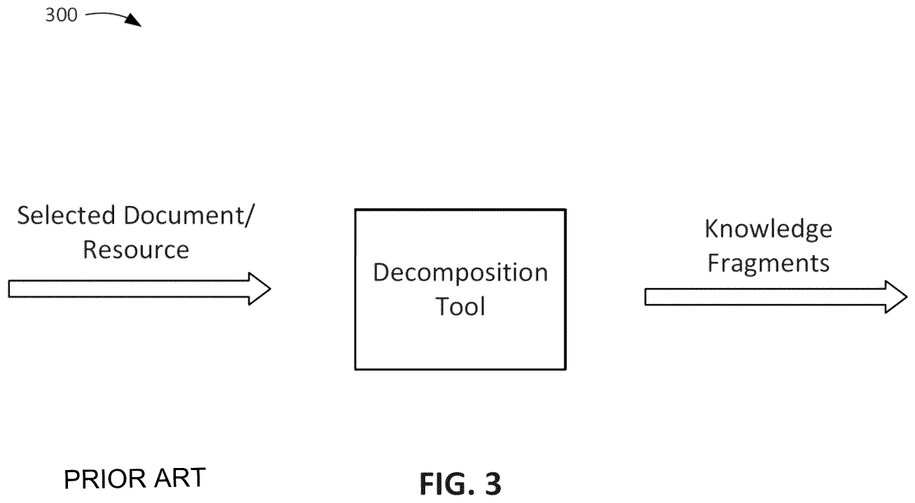

FIG. 3 illustrates an example diagram of a decomposition function performed by a decomposition tool. More specifically, the decomposition tool may receive one or more documents selected by the user from the results list of FIG. 2. Alternatively, the decomposition tool may receive one or more selected documents uploaded to the decomposition tool. The decomposition tool may process the one or more selected documents and output knowledge fragments in the form of a JSON object that may have notes associated with the selected documents. In some embodiments, the decomposition tool may be implemented and/or hosted by the comprehension engine 120.

In some embodiments, the decomposition tool may submit a selected document or resource to specific components of a natural language parser. One well-known example includes the GATE Natural Language Processor. GATE stands for “General Architecture for Text Engineering” and is a project of the University of Sheffield in the United Kingdom. GATE has a very large number of components, most of which have no bearing upon the comprehension engine. One embodiment of the comprehension engine utilizes a small subset of GATE components-a Serial Analyzer (called the “ANNIE Serial Analyzer”), a Document of Sentences, and a Tagger (called the “Hepple Tagger”) to extract Sentence +Token Sequence Pairs. The Sentence +Token Sequence Pairs are utilized by the decomposition tool.

The set of Sentence+Token Sequence Pairs are produced in GATE as follows: The Serial Analyzer extracts “Sentences” from an input Document. The “Sentences” do not need to conform to actual sentences in an input text, but often do. The sentences are “aligned” in a stack termed a Document of Sentences. Each Sentence in the Document of Sentences is then run through the Tagger which assigns to each word in the Sentence a part of speech token. The parts of speech are for the most part the same parts of speech well known to school children, although among Taggers, there is no standard for designating tokens. In the Hepple Tagger, a singular Noun is assigned the token “NN”, an adjective is assigned the token “JJ”, an adverb is assigned the token “RB” and so on. Sometimes, additional parts of speech are created for the benefit of downstream uses. The part of speech tokens are maintained in a token sequence which is checked for one-to-one correspondence with the actual words of the sentence upon which the token sequence is based.

Text analysis for the purpose of automated document classification or indexing for search engine-based retrieval is a primary use of part of speech patterns. Part of speech patterns and token seeking rules are used in text analysis to discover keywords, phrases, clauses, sentences, paragraphs, concepts and topics. Sometimes, the word phrase is defined using its traditional meaning in grammar. In this use, types of phrases include Prepositional Phrases (PP), Noun Phrases (NP), Verb Phrases (VP), Adjective Phrases, and Adverbial Phrases. For other implementations, the word phrase may be defined as any proper name (for example “New York City”). Most definitions require that a phrase contain multiple words, although at least one definition permits even a single word to be considered a phrase. Some search engine implementations utilize a lexicon (a pre-canned list) of phrases. The WordNet Lexical Database is a common source of phrases.

Two methods of resource decomposition applied in embodiments of the comprehension engine are word classification and intermediate format. Word classification identifies words as instances of parts of speech (e.g. nouns, verbs, adjectives). Correct word classification often requires a text called a corpus because word classification is dependent upon not what a word is, but how it is used. Although the task of word classification is unique for each human language, all human languages can be decomposed into parts of speech. In one embodiment, the human language decomposed by word classification is the English language, and the means of word classification is a natural language parser (NLP) (e.g. GATE, a product of the University of Sheffield, UK).

The second method of decomposition supported by the comprehension engine uses an intermediate format. The intermediate format is a first term or phrase paired with a second term or phrase. In an embodiment, the first term or phrase has a relation to the second term or phrase. That is, the first term or phrase, known as a first relatum, has a relation or bond with the second term or phrase, known as a second relatum. That relation is an implicit or explicit relation, and the relation is defined by a context. In various embodiments, the context may be a schema, a tree graph, or a directed graph (also called a digraph). In these embodiments, the context is supplied by the resource from which the pair of terms or phrases was extracted. In other embodiments, the context is supplied by an external resource. In accordance with one embodiment of the present invention, where the relation is an explicit relation defined by a context, that relation is named by that context.

In an example in which the decomposition takes as input a relational database (RDB) schema, a first term or phrase may be a database name such as, for example, “ACCOUNTING”, and a second term or phrase may be a database table name such as, “Invoice”. In this example the relation (e.g., “has”) between the first term or phrase, “Accounting”, and the second term or phrase, “Invoice”, is implicit due to semantics of the RDB schema. In this example, “Accounting” is a first relatum, “Invoice” is a second relatum, and a relation or bond therebetween is “has”.

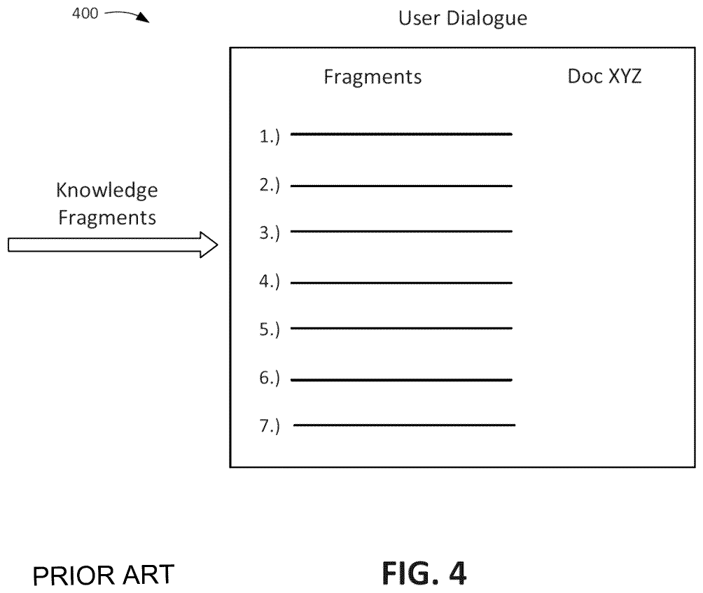

FIG. 4 illustrates an example of payload returned by the comprehension engine based on the knowledge fragments from FIG. 3. In this way, the user may view a visual representation of the comprehension engine's results or payload.

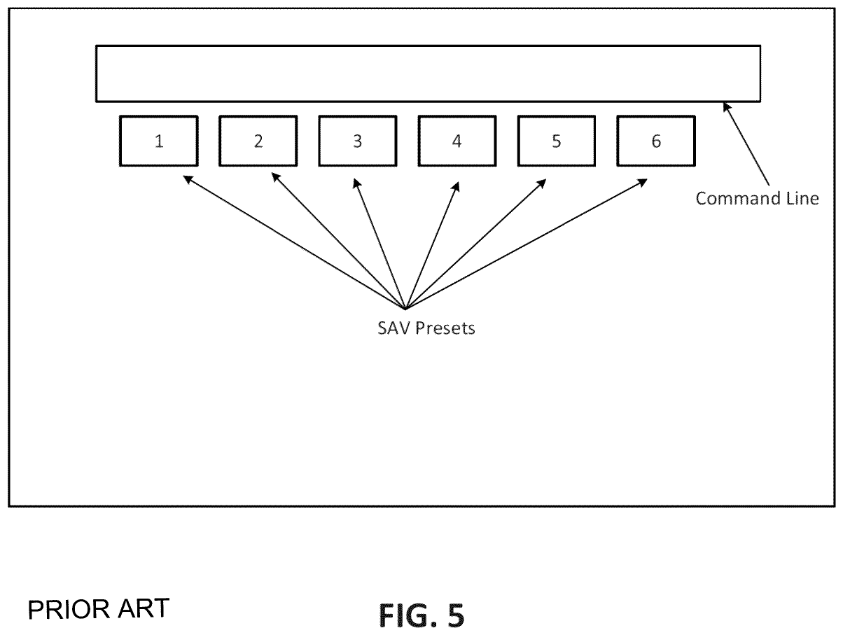

FIG. 5 illustrates a sorting analysis visualization (SAV) function. As shown in FIG. 5, the comprehension engine interface may include any number of SAV presets in which each preset may define the manner in which the comprehension engine payload is analyzed, sorted, or presented. Each SAV preset may be user or developer defined and modifiable. The presets may be stored by the comprehension engine and/or in another location. The SAV function may analyze the comprehension engine payload and form a visual network that models an interpretation or comprehension of the comprehension engine payload. In one example embodiment, relations may be assigned a weight. One example preset may include a filter to filter out relations that have a weight less than a given value such that those relations having weights less than the given value are hidden in a produced visualization. Another example preset may cause a visualization of an approximately centrally-located prime focus to be generated showing relata having a direct or indirect relation with the approximately centrally-located prime focus. Other presets may be included in other embodiments.

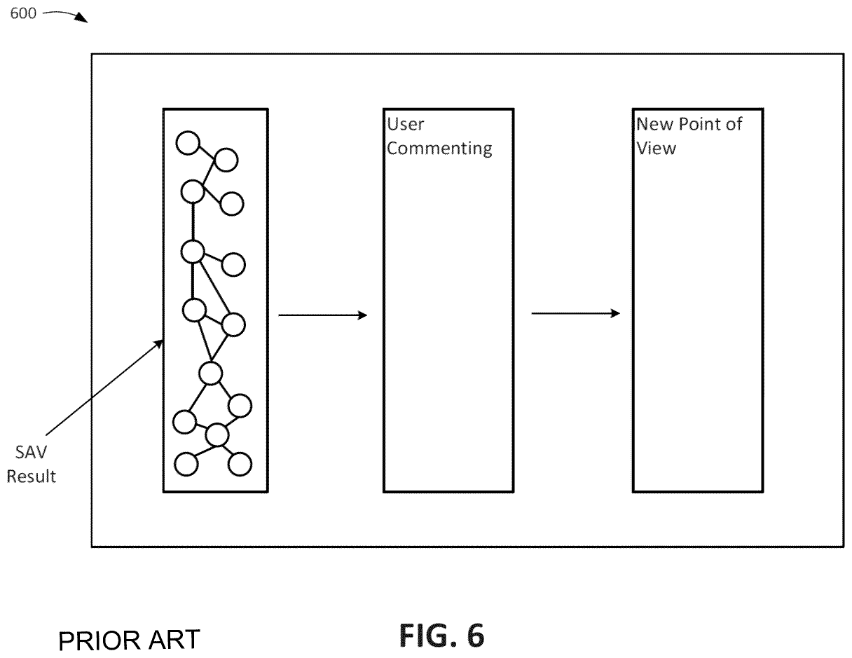

FIG. 6 illustrates a process for commenting on sorted, analyzed, and visualized comprehension engine payload to form a new point of view or interpretation/comprehension based on user comments. As shown in FIG. 6, interface 600 may present the SAV result produced at FIG. 5. The user may comment on the SAV result by changing or adding prime or subsidiary foci to the visualization and/or changing relations between foci by moving or deleting paths between foci. Based on the user's comments, a new point of view or interpretation/comprehension of the comprehension engine payload may be generated.

A prime focus is a collection of consecutive sentences in which a particular first relata has a frequency of occurrence greater than a frequency of occurrence of any other first relata included in knowledge fragments of the collection of sentences. In some embodiments, equivalent first relata may be treated as a same first relatum. For example, in some embodiments, first relata “dog” and “canine” may be treated as a same first relata having either a value of “dog” and/or “canine”. Two relata may be defined as equal if both relata either have a same value or have values that are considered to be equivalent.

A prime focus may be linked to one or more other prime foci and/or may be linked to one or more subsidiary foci. A subsidiary focus is a first relatum that is not a prime focus.

Various embodiments of the comprehension engine may process contents of a document and present a visualization showing prime foci, related subsidiary foci, and paths indicating relations therebetween to provide a user with an understanding of the contents in a very short period of time.

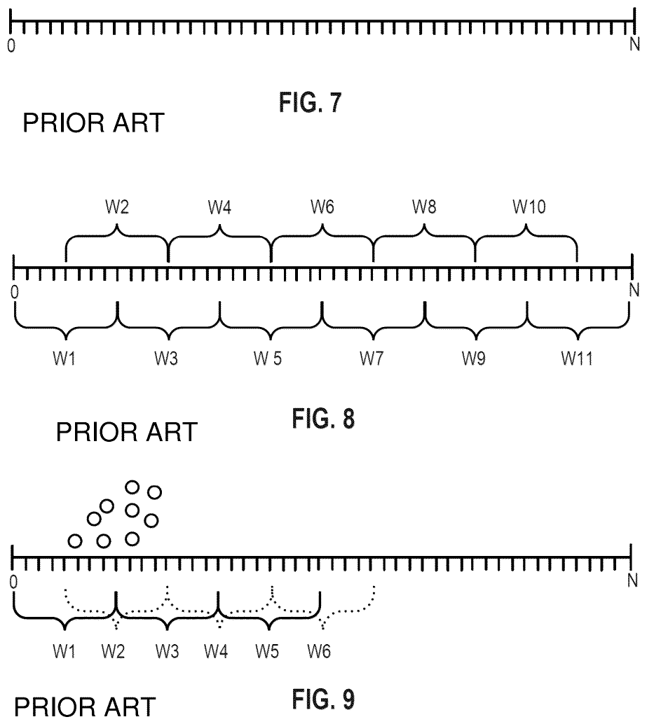

In an embodiment, as shown in FIG. 7, a computing device may prepare a visual presentation of N sentences included in contents of a document provided for analysis. The computing device may divide the sentences into a number of sections, or windows, which may overlap. As shown in FIG. 8, an example document may be divided into 11 windows, W1 through W11, each window having eight sentences, and each following window including some of the sentences from an immediately preceding window. For example, FIG. 8 shows window W1 having a first eight sentences of the document, window W2 having eight sentences beginning with a last four sentences of window W1, window W3 having eight sentences beginning with a last four sentences of window W2, window W4 having eight sentences beginning with a last four sentences of window W3, etc. In this example, when a number of remaining sentences not yet assigned to a window are less than half of a window size, then the remaining sentences may be included in a last window of the document such that the last window includes the number of remaining sentences and a last number of sentences from an immediately preceding window such that a window size of the last window has a same window size as other windows of the document. In other embodiments, windows may have a varying number of sentences.

Although the example shown in FIG. 8 has eleven windows of eight sentences with windows overlapping adjacent windows by half of a window size, other embodiments may divide a document into a different number of windows having a different number of sentences and with a different number of sentences overlapping adjacent windows.

FIG. 9 shows window W1 having four first relata (shown as small circles) with a same or equivalent values in knowledge fragments of sentences included in the window W1. Assuming that the four first relata outnumber a frequency of other first relata with other values in knowledge fragments of sentences included in the window W1, then the value(s) of these four first relata may become a prime focus candidate. Sliding a current window to adjacent window W2, which overlaps with the window W1, five more first relata are detected having the same or the equivalent values with respect to the four first relata of window W1. Thus, window W2 has nine first relata with the same or the equivalent values. Assuming that the same or the equivalent values of these first relata occur more frequently than other values of other first relata in windows W1 and W2, then the same or the equivalent values of the nine first relata become the prime focus in windows W1 and W2.

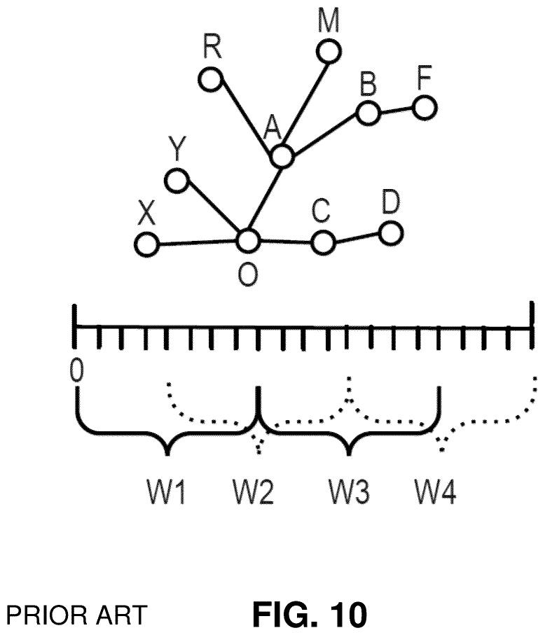

Various embodiments may determine a central prime focus of a document. A central prime focus is a prime focus located at an approximate central location of contents of the document. Other first relata having either a direct or indirect relation with the central prime focus may be determined. That is, first relata in knowledge fragments of the document having a related second relatum with a value of the central prime focus are considered to be directly related to the central prime focus. Other first relata in knowledge fragments having a second relatum with a value of a first relatum that is related to another second relatum having a relation through one or more other relata to the central prime focus are considered to be indirectly related to the central prime focus. FIG. 10 shows an example display screen showing a central prime focus O with direct relations to relata X, Y, A and C. Relatum D has an indirect relation with central prime focus O through relatum C. Relata R, M and B have an indirect relation with central prime focus O via relatum A. Relatum F has an indirect relation with central prime focus O via relata B and A. Lines between relatum are paths representing relations between the relatum.

In some embodiments one of the prime foci may be selected from a display such as, for example, a display as shown in FIG. 9 or another display. Other first relata having either a direct or indirect relation with the selected one of the prime foci may be determined. If prime focus O is the selected one of the prime foci, then FIG. 10 may be seen as an example display screen showing the selected one of the prime foci O with direct relations to relata X, Y, A and C, an indirect relation with relatum D through relatum C, indirect relations with relata R, M and B via relatum A, and an indirect relation with relatum F via relata B and A. Lines between relata are paths representing relations between the relata.

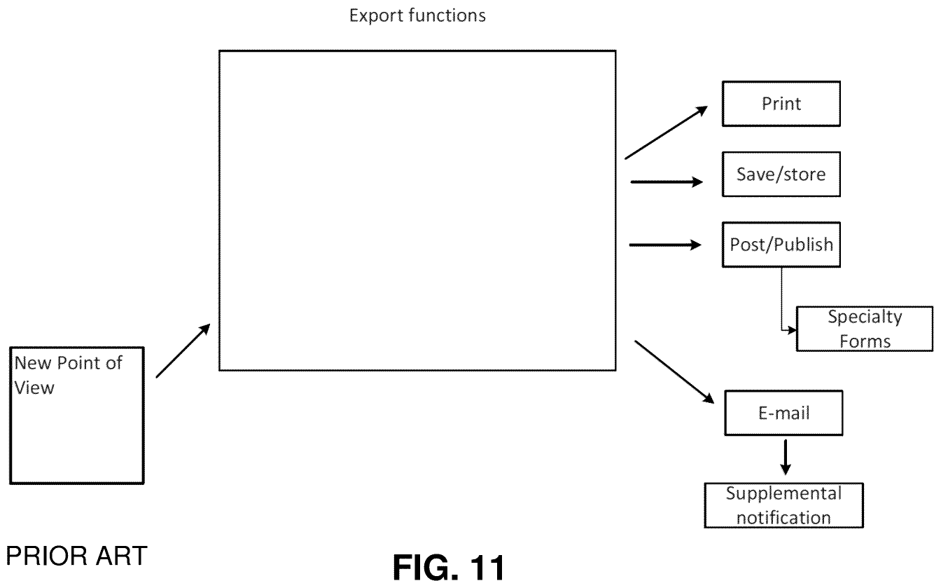

FIG. 11 illustrates an example of export functions that may be implemented in accordance with aspects of the present disclosure. As shown in FIG. 11, the final output (e.g., the new point of view after processing the user's comments) may be exported in a variety of formats (e.g., printing, storing/saving, posting/publishing, such as to specialty forms or social media, e-mail with supplemental notifications, etc.).

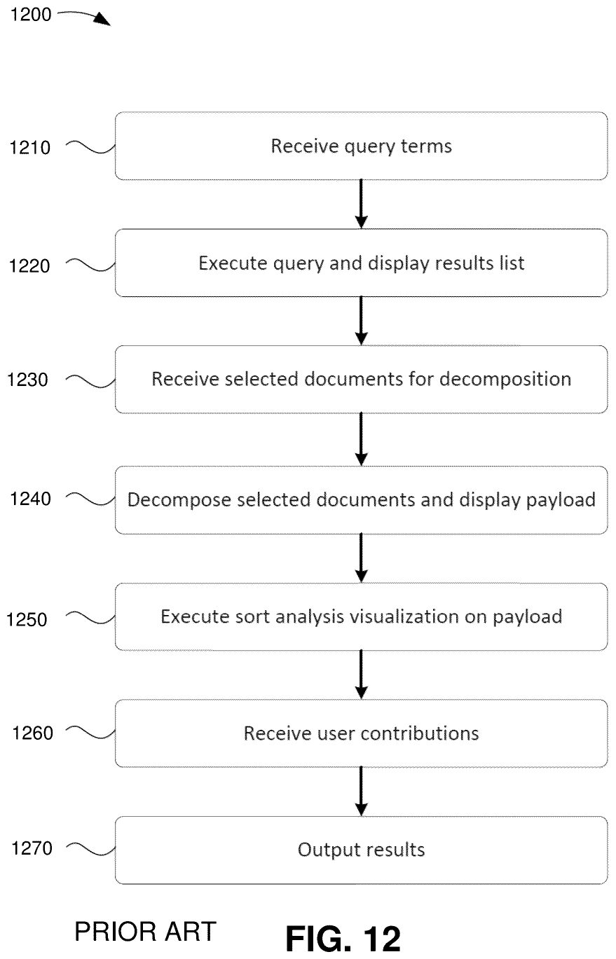

FIG. 12 illustrates an example flowchart of a process for executing a comprehension engine to produce a comprehension of selected documents. The blocks of FIG. 12 may be implemented by the comprehension engine 120. As noted herein, the flowchart illustrates the architecture, functionality, and operation of possible implementations of systems, methods, and computer program products according to various embodiments of the comprehension engine.

As shown in FIG. 12, a process 1200 may include receiving one or more query terms (block 1210). For example, the comprehension engine 120 may receive the one or more query terms (e.g., as described above with respect to FIG. 1).

The process 1200 also may include executing a search based on the one or more query terms and displaying a results list (block 1220). For example, the comprehension engine 120 may execute a search using any search algorithm or engine and display the results list (e.g., as described above with respect to FIG. 2).

The process 1200 further may include receiving selected documents for decomposition (block 1230). For example, the comprehension engine 120 may receive a selection of documents for decomposition (e.g., documents selected by the user to be of greatest interest).

The process 1200 also may include decomposing the selected documents and displaying the payload (block 1240). For example, the comprehension engine 120 may decompose the selected documents and display the resulting payload (e.g., as described above with respect to FIGS. 3 and 4).

The process 1200 further may include executing sort, analysis, and visualization (SAV) on the payload (block 1250). For example, the comprehension engine 120 may execute SAV on the payload (e.g., as described above with respect to FIG. 5). In some embodiments, a sort, analysis or visualization technique used may be based on a selected SAV preset.

The process 1200 also may include receiving user contributions (block 1260). For example, the comprehension engine 120 may receive user contributions (e.g., as described above with respect to FIG. 6). In some embodiments, the comprehension engine 120 may produce an updated or new point of view (e.g., updated comprehension/interpretation of the payload from block 1230).

The process 1200 further may include outputting results (block 1270). For example, the comprehension engine 120 may output the final results (e.g., the comprehension/interpretation of the payload after the user has commented, as described above with respect to FIGS. 6 and 11).

By introducing the decomposition tool, the process 1200 illustrates a computer-assisted system to improve information flow that allows for A.) interchangeability of tools at each level, including the decomposition tool; B.) the shifting of the user's focus from independent tools to an information flow that is dynamic with feedback loops, iteration cycles, inclusion of outside commentary, and additional feedback loops; C.) continuous updating of the comprehension by other users based on a repetition of the process 1200 over time; and D.) tools becoming “invisible” from the user's perspective (as well as interchangeable).

The process 1200 may be repeated continuously over the course of time in which each result is based on a user contribution. Each result may be fed back as an input to process 1200. Thus, after each cycle of process 1400, the flow of information and level of comprehension improves over time.

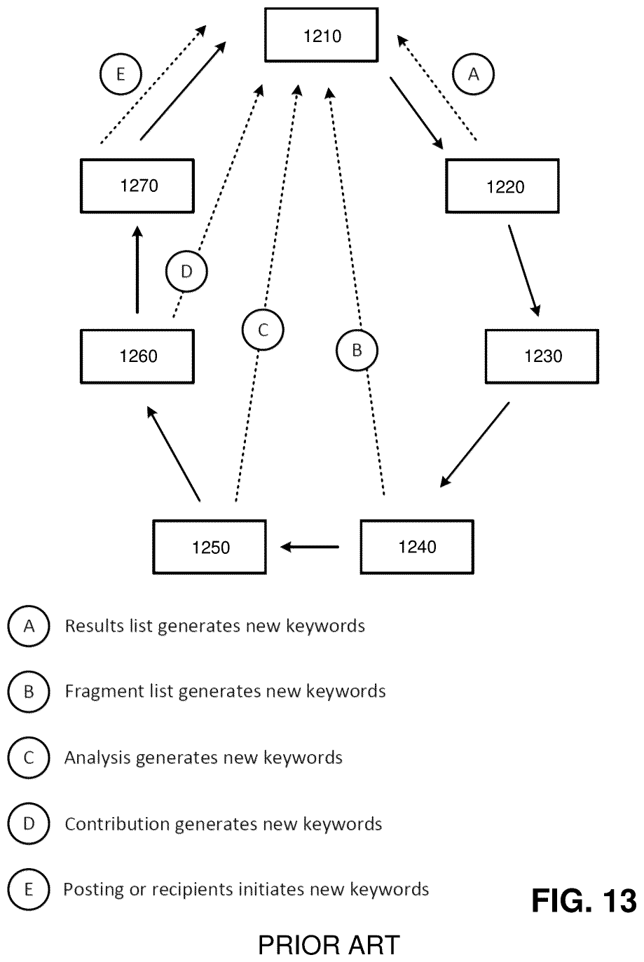

FIG. 13 illustrates an example flow diagram of data that may be fed back for refining the comprehension engine processes. As shown in FIG. 13, outputs from blocks in process 1200 may be input into other blocks in process 1200. For example, outputs from process block 1220 may include results list, which may be used to generate new keywords (e.g., query terms) which may be inputted into block 1210. Similarly, a knowledge fragment list from block 1240 may generate new keywords. In some embodiments, the analysis from block 1250 may generate new keywords. Additionally, or alternatively, user contributions, from block 1260, may generate new keywords. Also, exporting the final results (e.g., posting to social media, or a recipient of the final results export) may initiate new keywords.

Aspects of the comprehension engine may be implemented in a variety of software platforms, tools, word processors, web browsers, etc. Thus, the systems and/or methods, described herein may be agnostic to which software tools the users choose to use. That is, aspects of the comprehension engine may focus on information flow rather than tool selection, which may be a matter of user preference. Aspects of the comprehension engine may provide a system of shifting user focus on disparate (and possibly disconnected) tools to a unified flow of information. Aspects of the comprehension engine may provide a dynamic system of information uptake, comprehension, supplemented with user creativity, and exposure to other users for further comment, with each exported item being considered a step along an endless path of knowledge discovery. As an illustrative example for the purposes of further explanation, information may begin to appear like a motion picture, with a single user input being one frame. Each new user input may add one or more frames to the motion picture (e.g., information flow).

### Foci Analysis Tool

Various embodiments of a foci analysis tool may process contents of a document and present a visualization showing prime foci, related subsidiary foci, and paths indicating relations therebetween to provide a user with an understanding of the contents in a very short period of time.

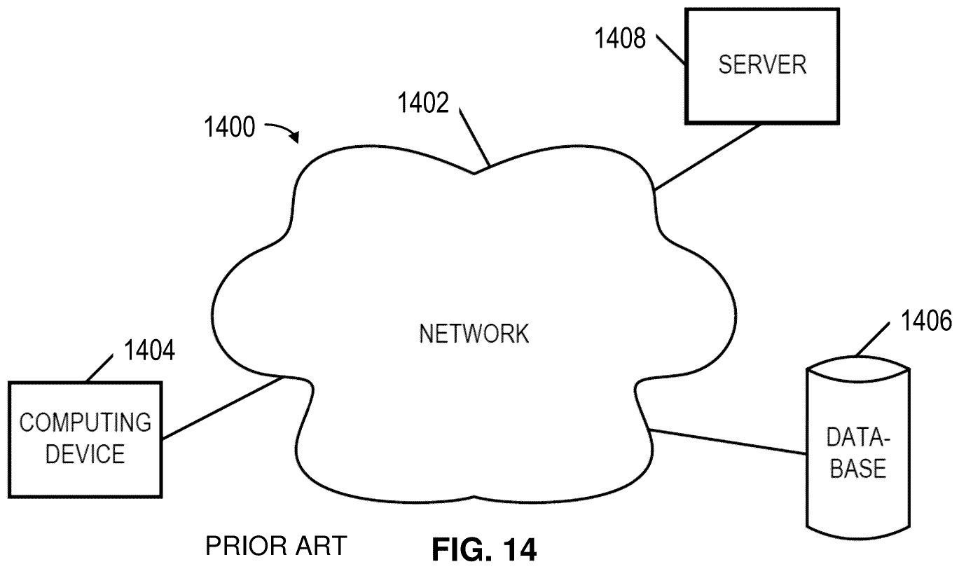

FIG. 14 illustrates an example environment 1400 in which embodiments of the foci analysis tool may be implemented. Environment 1400 may include a network 1402, a computing device 1404, a database 1406, and a server 1408.

Network 1402 may be implemented by any number of any suitable communications media (e.g., wide area network (WAN), local area network (LAN), Internet, Intranet, etc.) or a combination of any of the suitable communications media. Network 1402 may further include wired and/or wireless networks.

Computing device 1404 may include a desktop computer, a laptop computer, a smartphone, a tablet computer, or other type of computing device and may be connected to network 102 via a wired or wireless connection.

Server 1408 may include a single computer or may include multiple computers configured as a server farm. The one or more computers of server 1408 may include a mainframe computer, a desktop computer, or other types of computers. Server 1408 may be connected to network 1402 via a wired or a wireless connection.

Database 1406 may include a database management system and its contents. In some embodiments, the database management system may be a relational database management system such as, for example, SQL or another database management system. In some embodiments, database 1406 may be directly connected with server 1408. Server 1408 and database 1406 may be included in a cloud computing environment in some embodiments.

In some embodiments, a user of computing device 1404 may submit a document to server 1408, which analyzes contents of the document and provides one or more visualizations to computing device 1404 via network 1402. In an alternate embodiment, computing device 1404 may include a standalone embodiment in which a user selects a document stored on a computer-readable medium of computing device 1404, and computing device 1404 analyzes contents of the document and presents one or more visualizations to a user via a display screen.

In an embodiment, as shown in FIG. 7, computing device 1404 or server 108 may prepare a visual presentation of N sentences included in contents of a document provided for analysis. Computing device 104 or server 108 may divide the sentences into a number of sections, or windows, which may overlap. As shown in FIG. 8, an example document may be divided into 11 windows, W1 through W11, each window having eight sentences, and each following window including some of the sentences from an immediately preceding window. For example, FIG. 8 shows window W1 having a first eight sentences of the document, window W2 having eight sentences beginning with a last four sentences of window W1, window W3 having eight sentences beginning with a last four sentences of window W2, window W5 having eight sentences beginning with a last four sentences of window W3, etc. In this example, when a number of remaining sentences not yet assigned to a window are less than half of a window size, then the remaining sentences may be included in a last window of the document such that the last window includes the number of remaining sentences and a last number of sentences from an immediately preceding window such that a window size of the last window has a same window size as other windows of the document. In other embodiments, windows may have a varying number of sentences.

As mentioned previously, although the example shown in FIG. 8 has windows of eight sentences with windows overlapping adjacent windows by half of a window size, other embodiments may divide a document into a different number of windows having a different number of sentences and with a different number of sentences overlapping adjacent windows.

In some embodiments, a prime focus may be selected from a display such as, for example, a display as previously shown in FIG. 9 or another display. If prime focus O is the selected prime focus, then FIG. 10 may be seen as an example display screen showing the selected one of the prime foci O with direct relations to relata X, Y, A and C, an indirect relation with relatum D through relatum C, indirect relations with relata R, M and B via relatum A, and an indirect relation with relatum F via relata B and A. Lines between relata are paths representing relations between the relata.

In some embodiments, a filter may be set to hide items in a visualization. In one embodiment, the filter may hide paths and foci based on a strength or weight of a relation between foci. For example, a displayed numerical value appearing next to a path may indicate a strength or weight of a relationship. In some embodiments, higher numerical values indicate a stronger relation or greater weight between relata than lower numerical values. In other embodiments, lower numerical values may indicate a stronger relation or greater weight between relata. Some other embodiments may indicate a strength or weight of a relation by showing one or more letters such as “L” for low, “M” for medium, and “H” for high, or yet other letters with different strength or weight meanings. A strength or weight of a relation may be determined by one or more words used to describe the relation. In some embodiments, groups of one or more words describing relations may have a strength or weight configurable by a user. Thus, a strength or weight of a relation may be determined by the one or more words that describe the relation, and may be different for different users.

In some embodiments, words that appear in relata may be configured by a user to have assigned strengths or weights. An associated filter may be set to a desired value and relata that normally would be displayed in a visualization may become hidden if the assigned weight or strength of the word or groups of words associated with the relata is less than the associated filter setting. Paths to such relata also may become hidden in the visualization.

Various embodiments provide users with a quick understanding of document contents in a very short amount of time. For example, prime foci and relations among prime foci, subsidiary foci, and other relata can be easily understood via multiple visualizations. An ability to select a prime focus among multiple prime foci and be presented with relations to other prime foci and subsidiary foci provides a powerful tool for a user to understand various themes and relations among the themes.

### Emerging Mind

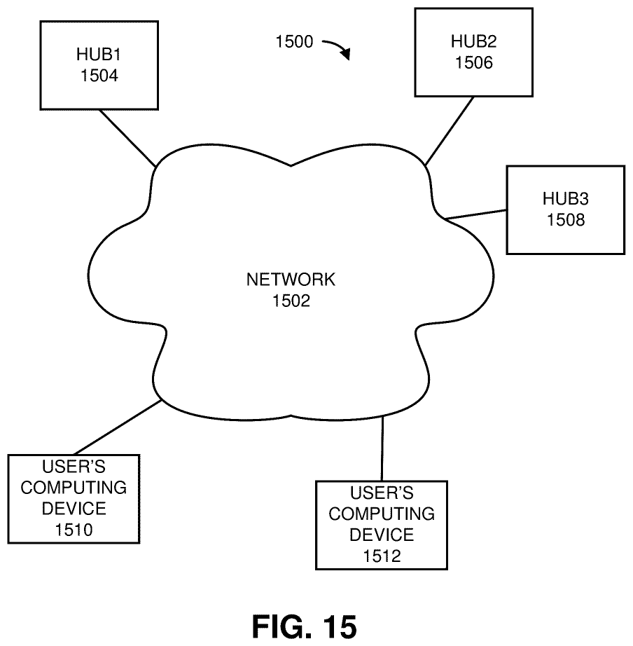

FIG. 15 illustrates an example environment 1500 in which various embodiments of an emerging mind may be implemented. Environment 1500 may include a network 1502, HUB1 1504, HUB2 1506, HUB3 1508, and user's computing devices 1510, 1512.

Network 1502 may implemented by any number of any suitable communications media (e.g., wide area network (WAN), local area network (LAN), Internet, Intranet, etc.) or a combination of any of the suitable communications media. Network 1502 may further include wired and/or wireless networks.

User computing devices 1510, 1512 may include a desktop computer, a laptop computer, a smartphone, a tablet computer, or other type of computing device and may be connected to network 1502 via a wired or wireless connection.

HUB1 1504, HUB2 1506, and HUB3 1508 may include a mainframe computer, a desktop computer, or other types of computers. HUB1 1504, HUB2 1506, and HUB3 1508 may be connected with network 1502 via wired or wireless connections.

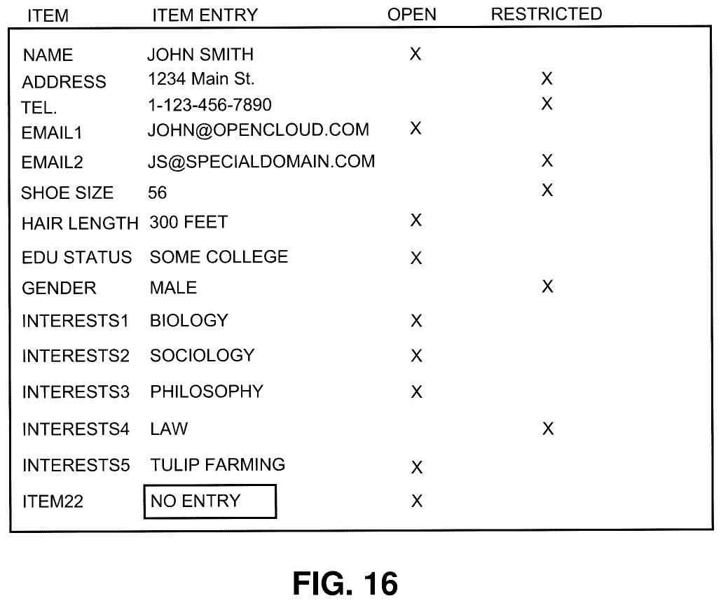

FIG. 16 refers to a profile of a user that, in some embodiments, may be stored within another program (such as a comprehension engine executing on a user's computing device) and may always be stored on the user's computing device. Control over profile entries and permissions to display profile entries may always be under each respective user's control. In various embodiments, there may be no replication to any sort of offsite partner, such as a cloud.

The profile itself may have a number of columns for entries which from left to right may comprise i) in column a, names of entries in column b, ii) in column b, actual entries matching items in column a immediately left of column b, and iii) a slide bar, switch, or button which can alternate between open (meaning anyone and any program with access to the profile can read the entry in columns a and b, or restricted (meaning that not only can no one else read that row of entries in columns a and b, it also means no one can know at all whether there is any entry in that row at all).

Further, the profile may be encrypted by the user and should not be able to be hacked.

The number of rows in which column a and b reside is not restricted to a template provided by a program vendor. Any user can add any number of new items to his/her profile such as more interests, etc. Each row may have its own slide bar, switch, or button to indicate whether that row is open or restricted. Further, the profile may be initiated only from a user.

Only a user can volunteer a connection to a HUB (a simple call mechanism may initiate a call). This creates a two phase commit process . . . a user initiates a connection to a HUB, the HUB responds by accepting.

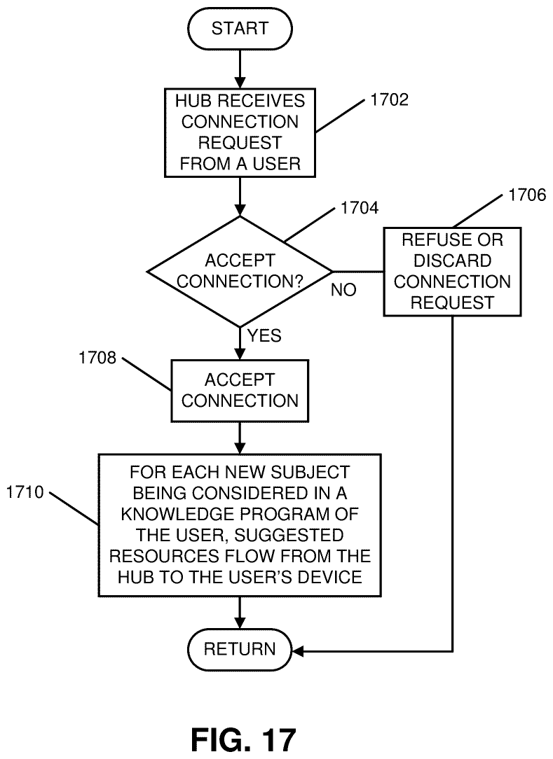

FIG. 17 is a flowchart of an example process in which a HUB receives a connection request from a user's computing device. The process may begin with the HUB receiving the connection request initiated by a user at the user's computing device (act 1702). The HUB then may determine whether to accept the connection request (act 1704). In some embodiments, the HUB may accept the connection request only if all entries in a profile of the user are open. In other embodiments, the HUB may accept the connection request only if specific entries in the profile of the user are open. In yet other embodiments, other criteria may be used by the HUB to determine whether to accept the connection request.

If the criteria used by the HUB to determine whether to accept the connection request are not satisfied, then the HUB may refuse or discard the connection request (act 1706) and the process may be completed. If the connection request is discarded, then the user's computing device may assume that the connection request is not accepted upon expiration of a connection timer that was started when the connection request was sent to the HUB. The connection timer may be set to 20 seconds, 30 seconds, 60 seconds, or another suitable period of time.

If, during act 1704, the HUB determines that all criteria for accepting the connection request are satisfied then the HUB may accept the connection by sending a connection acknowledgment to the user's computing device (act 1708). In embodiments, the HUB may generate a unique HUB identifier number and may include the HUB identifier number in the connection acknowledgement sent to the user's computing device, which may be stored with the user's profile in the user's computing device, thereby enabling interaction with the HUB. After a connection between the user's computing device and the HUB is established, then for each new subject being considered in a knowledge program such as, for example, the comprehension engine executing on the user's computing device, the HUB may scavenge available databases to find related resources and contacts, which may flow from the HUB to the user's computing device, where they may be stored in a frame of reference as will be described later.

Any user can have N numbers of HUBs at his or her disposal depending on a user's interests.

A HUB may be a centrally located interchange where additional resources of varied nature (contacts, content and new analytical methods) can be accessed. A computing device may include only one HUB executing thereon, or may include multiple HUBs executing thereon. Any organization or human being can establish a HUB simply by hosting the HUB on a computing device and making the HUB's presence known.

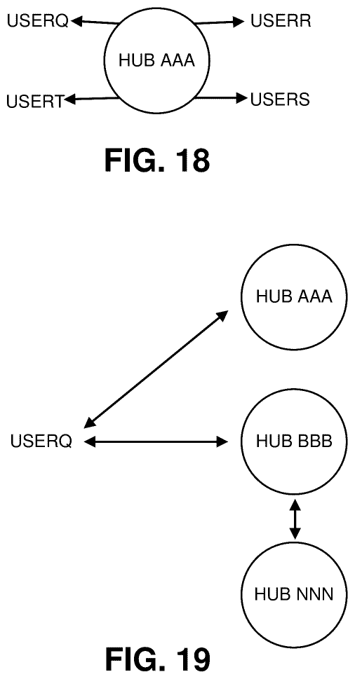

A first illustration in FIG. 18 shows a one to many relationship whereby HUB AAA communicates with four users, USERQ, USERR, USERS, and USERT.

A second illustration in FIG. 19 centers on USERQ who is directly connected with HUB AAA and HUB BBB, and possibly extending to HUB NNN through HUB BBB. This is an example of a one to many relationship, focused on a user.

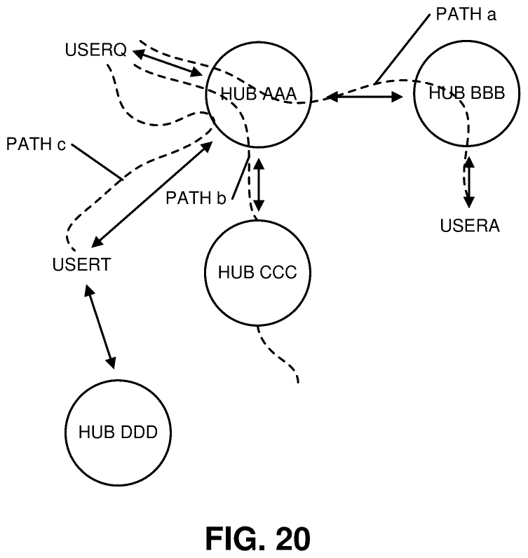

A third illustration is where an emerging mind aspect of various embodiments starts to show itself. The third illustration in FIG. 20 illustrates how knowledge can grow from USERQ's point of view. Path a is where User Q is connected to HUB AAA, which is connected to HUB BBB and which is connected to USERA. Path b is where User Q is connected to HUB AAA, which is connected to HUB CCC, and from there to resource xxxx (not shown). Path c is where USERQ is connected to HUB AAA, which is connected with USERT who is also connected to HUB DDD.

A means by which a HUB retains knowledge can be active or passive, meaning an active HUB may maintain a database which is periodically refreshed by searches across the HUB's user pool. New links and contacts are automatically found and retained in an active database. Alternatively, a central store could be more passive, meaning that only information from active users may be retained in an index system.

Upon receipt of a request from a user to connect, the HUB would a) agree to the connection and then send a unique HUB identifier (ID) number to the user for inclusion in his or her profile. That unique ID can be an identifier that unlocks the HUB's resources and capabilities. Suggested resources from the HUB to the user can flow automatically for each new subject being considered in the user's knowledge program such as, for example, the Comprehension Engine. Thus, in some embodiments, the user's knowledge program may report to the HUB each new subject being considered by the user.

A first HUB may actively solicit a direct connection to a second HUB. As a result, a user of a user's computing device, whether attached to the first HUB or the second HUB, would gain access to resources across the network based on information received from the first HUB and the second HUB.

In some embodiments, HUBs may be located inside a firewall, creating a “walled garden” for an organization to pursue its purpose. That “walled garden” HUB may be connected to an external user or an external HUB.

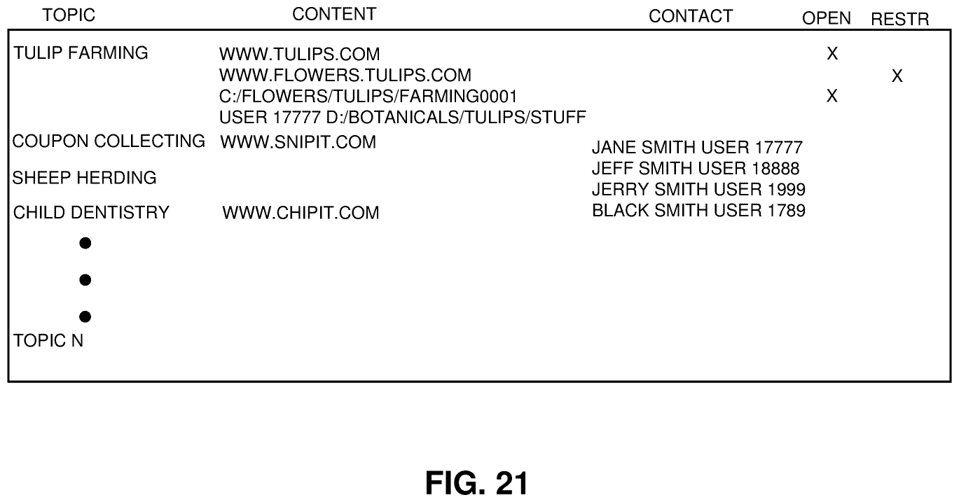

An example frame of reference, illustrated in FIG. 21, may be encrypted inside a user's computing device to ensure data privacy, may be keyed to the unique HUB ID number assigned by a HUB, and may have a number of columns to incorporate material generated during a knowledge journey. In some embodiments, topics discovered by a knowledge program such as, for example, the comprehension engine of the user, may be included in the frame of reference. Information related to topics included in the frame of reference may be provided by the HUB to the user's computing device for storage to the frame of reference. The information may be provided by the HUB to which the user's computing device is connected as well as any other HUB that may be connected through that HUB. The information may be gathered by the HUB, and any other connected HUBs, by each of the one or more connected HUBs scavenging available databases for topic-related information such as, for example, content related to topics of interest to a user, user IDs of users who are knowledgeable about the topic, etc.

In FIG. 21, an area of interest to the user, “tulip farming” shows some suggested web sites, a document only available on a user's computing device of User 17777 and some suggested contacts, identified by their own unique user ID numbers. An Open/Restricted control is shown for each suggested web site entry and the document of the user only available on the user's computing device to bring control under the user's personal command. Some items are shown below tulip farming to illustrate how additional items of interest can create a vivid frame of reference.

It is possible for an unforeseen link to appear in a user's frame of reference between two seemingly unrelated topics. At some point the frame might be able to establish a link, creating a possibility of new knowledge buried in one person's frame.

As the user works on some topic or subject, that topic or subject may be shown in a first column. In other columns, new suggested resources or suggested contacts may be shown. There may also be an Open/Restricted button or slide for each entry to bring control under the user's personal command.

Some items are shown below tulip farming to illustrate how additional items of interest can create a vivid frame of reference both by enabling the user to expand his or her own frame of reference, but also to expand the frame of reference for anyone who is connected to that user through an appropriate hub. A network effect is possible. For example, USERX on a first user's computing device may be connected to HUB ABC, which is connected to HUB DEF, which is connected to a USERY. As a result, USERX may have access to resources of HUB ABC as well as access to resources of HUB DEF.

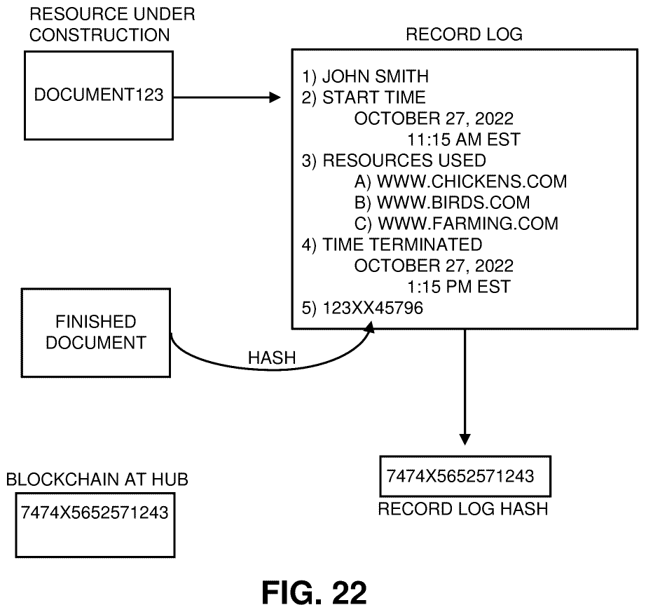

A record log stored on a user's computing device plus a hash of that record log stored at a block chain at a HUB creates an indelible record of all knowledge creation. See FIG. 22. In FIG. 22, document 123 is being created to pursue knowledge comprehension and generation. Simultaneously, a record log is opened which records details of the work in progress. Such things as author, start time, resources used, time terminated, etc. are noted and stored to the record log. When document 123 is completed, a hash of document 123 is added to the record log and the record log is then itself hashed. This record log hash may be sent to a blockchain, which is kept at the HUB. In this way, ownership of the work can be claimed and verified by the author while independent and indelible proof of such authorship may be kept in the blockchain at the HUB. The blockchain does not permit later stage editing, so anyone attempting to modify a file will be unable to.

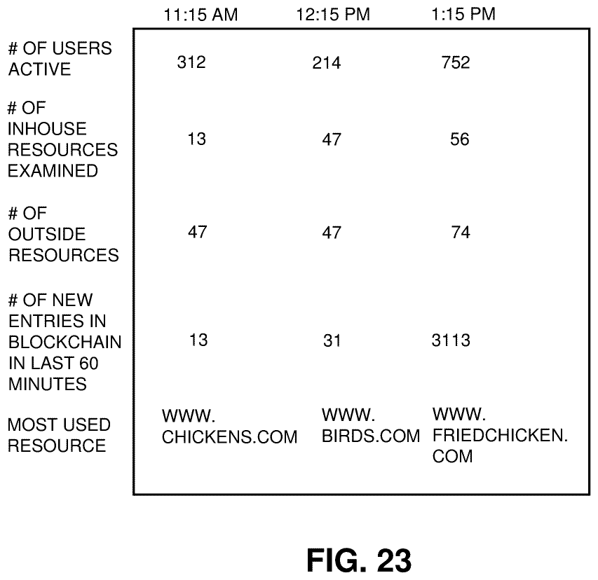

All of this enables a dashboard at the HUB level where an administrator or an information officer can monitor group and individual knowledge creation, generation, and dissemination related to a Hub. See FIG. 23.

The dashboard may show a convenient series of time slices in which all sorts of statistics generated by a pool of users associated with the HUB can be shown. This is a natural outgrowth of the management of the HUB. In the example dashboard of FIG. 23, various statistics may be displayed at multiple time slices. The statistics may include a number of active users, a number of inhouse resources examined, a number of outside resources, a number of new entries in a blockchain in a last predefined time interval, and most used resource. As shown in FIG. 23, time slices may occur at 60 minute time intervals. In other embodiments, time slices may occur at another time interval and the statistics displayed may be different from those displayed in FIG. 23.

An organization could place its document creating and editing software inside a pool behind a firewall. The organization could be a school system, enterprise, government entity, etc. with free exchange within a pool of users within the organization, but limited exchange with the outside world.

In the various embodiments privacy is preserved where possible.

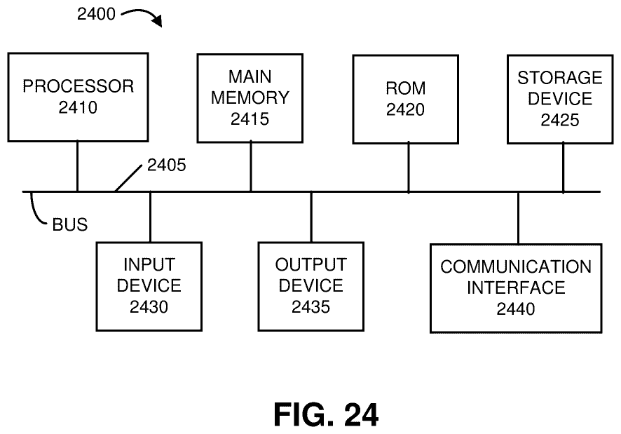

FIG. 24 illustrates example components of a device 2400 that may be used in accordance with aspects of the present disclosure as well as aspects of a comprehension engine and a foci analysis tool. Device 2400 may correspond to a user's computing device 1510, 1512, a HUB 1504, 1506, 1508, a computing device 1404, a server 1408, or a client device 110.

As shown in FIG. 24, device 2400 may include a bus 2405, a processor 2410, a main memory 2415, a read only memory (ROM) 2420, a storage device 2425, an input device 2430, an output device 2435, and a communication interface 2440.

Bus 2405 may include a path that permits communication among the components of device 2400. Processor 2410 may include a processor, a microprocessor, an application specific integrated circuit (ASIC), a field programmable gate array (FPGA), or another type of processor that interprets and executes instructions. Main memory 2415 may include a random access memory (RAM) or another type of dynamic storage device that stores information or instructions for execution by processor 2410. ROM 2420 may include a ROM device or another type of static storage device that stores static information or instructions for use by processor 2410. Storage device 2425 may include a magnetic storage medium, such as a hard disk drive, or a removable memory, such as a flash memory.

Input device 2430 may include a component that permits an operator to input information to device 2400, such as a control button, a keyboard, a keypad, or another type of input device. Output device 2435 may include a component that outputs information to the operator, such as a light emitting diode (LED), a display, or another type of output device. Communication interface 2440 may include any transceiver-like component that enables device 2400 to communicate with other devices or networks. In some implementations, communication interface 2440 may include a wireless interface, a wired interface, or a combination of a wireless interface and a wired interface. In embodiments, communication interface 2440 may receive computer readable program instructions from a network and may forward the computer readable program instructions for storage in a computer readable storage medium (e.g., storage device 2425).

Device 2400 may perform certain operations, as described in detail below. Device 2400 may perform these operations in response to processor 2410 executing software instructions contained in a computer-readable medium, such as main memory 2415. A computer-readable medium may be defined as a non-transitory memory device and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A memory device may include memory space within a single physical storage device or memory space spread across multiple physical storage devices.

The software instructions may be read into main memory 2415 from another computer-readable medium, such as storage device 2425, or from another device via communication interface 2440. The software instructions contained in main memory 2415 may direct processor 2410 to perform processes that will be described in greater detail herein. Alternatively, hardwired circuitry may be used in place of or in combination with software instructions to implement processes described herein. Thus, implementations described herein are not limited to any specific combination of hardware circuitry and software.

In some implementations, device 2400 may include additional components, fewer components, different components, or differently arranged components than are shown in FIG. 24.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may include a system, a method, and/or a computer program product at any possible technical detail level of integration. The computer program product may include a computer readable storage medium (or media) having computer readable program instructions thereon for causing a processor to carry out or execute aspects and/or processes of the present disclosure.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on a user's computer, partly on the user's computer, as a stand-alone software package, partly on the user's computer and partly on a remote computer or entirely on the remote computer or server.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code-it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While the present disclosure has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the disclosure.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

1. A computing device comprising:
at least one first processor;
a first main memory; and
a first communication interface, the first main memory, and the first communication interface being connected to the at least one first processor via a first bus, wherein
the first main memory includes instructions for configuring the at least one processor to perform:
creating a record log on the computing device upon creation of a document on the computing device, the record log including a name of a user who created the document, and a start time indicating a time and date of creation of the document;
upon completion of the document, performing:
calculating a first hash of the completed document,
storing the first hash to the record log,
calculating a second hash of contents of the record log, and
providing the second hash for storage to a blockchain residing in a hub executing on a different computing device.

2. The computing device of claim 1, wherein the instructions further configure the at least one processor to perform:
upon completion of the document, storing to the record log a time and a date at which the document is completed.

3. The computing device of claim 1, wherein the instructions further configure the at least one processor to perform:
storing, in the record log, resource information indicating one or more resources used while the document is under construction.

4. The computing device of claim 1, wherein the instructions further configure the at least one processor to perform:
sending a connection request to the hub responsive to a user initiation of the connection request;
receiving, in response to the sending of the connection request to the hub, an acceptance of the connection request; and
receiving suggested resources from the hub after receiving the acceptance of the connection request, the received suggested resources being based on each subject being considered by a knowledge process executing on the computing device.

5. The computing device of claim 4, wherein the knowledge process is a comprehension engine.

6. The computing device of claim 1, wherein the instructions further configure the at least one processor to perform:
maintaining a user profile on the computing device, the user profile including names of entries, actual entries related to the names of the entries, an indicator for each respective entry which can alternate between being open or restricted, an open indicator allowing access to the respective entry, and a restricted indicator denying access to the respective entry.

7. The computing device of claim 1, wherein the instructions further configure the at least one processor to perform:
communicating to the hub a topic being worked on by the user;
receiving, from the hub responsive to the communicating to the hub, information including one or more respective links to one or more documents on the topic and suggested contacts who are knowledgeable on the topic; and
adding the received information to a frame of reference on the computing device.

8. A computer-readable medium having instructions stored thereon for a processor of a computing device, wherein the instructions configure the processor to perform:
receiving, from a user computing device, first information including a topic that a user was working on at the user computing device;
scavenging available databases for second information related to the topic; and
providing the second information to the user computing device for inclusion in a frame of reference of the user.

9. The computer-readable medium of claim 8, wherein the instructions further configure the processor to perform:
receiving a connection request from a second user of a second user computing device;
determining whether requirements for accepting the connection request from the second user are satisfied; and
accepting the connection request from the second user only if the requirements for accepting the connection request are satisfied.

10. The computer-readable medium of claim 9, wherein the determining whether the requirements for accepting the connection request from the user are satisfied further comprise:
determining that the requirements for accepting the connection request are satisfied either:
when the requirements for accepting the connection request are determined not to exist, or
when the requirements for accepting the connection request do exist, and the requirements are satisfied.

11. The computer-readable medium of claim 9, wherein the requirements for accepting the connection request are related to an amount of disclosure permitted regarding items from a profile of the second user.

12. The computer-readable medium of claim 8, wherein the instructions further configure the processor to perform:
providing to one or more certain users a view of workflow of a plurality of users having respective user computing devices connected with a hub executing on the computing device.

13. The computer-readable medium of claim 12, wherein the view includes snapshots over a plurality of time slots, the snapshots including at least two items from a group of items consisting of a number of active users, a number of inhouse resources examined, a number of outside resources used, a number of new entries added to a blockchain in a last predefined number of minutes, and one or more most used resources.

14. A machine-implemented method executing on a user computing device connected to a hub executing on a second computing device, the method comprising:
providing, to the hub, first information including one or more topics that a user was working on at the user computing device;
receiving from the hub second information, at least some of the second information being related to the first information provided to the hub; and
including the second information in a frame of reference of the user, the frame of reference including one or more topics of interest to the user, and one or more references to content associated with the one or more topics of interest.

15. The machine-implemented method of claim 14, wherein the second information included in the frame of reference further includes contact information of one or more users who are knowledgeable regarding at least one of the one or more topics.

16. The machine-implemented method of claim 14, wherein at least some entries in the frame of reference include an indication regarding whether a respective entry is accessible to others or restricted from being accessed by the others.

17. The machine-implemented method of claim 14, further comprising:
creating a record log on the user computing device upon creation of a document, the record log including a name of a user who created the document, and a start time indicating a time and date of creation of the document;
upon completion of the document, performing:
calculating a first hash of the completed document,
storing the first hash to the record log,
calculating a second hash of contents of the record log, and
providing the second hash for storage to a blockchain residing in the hub.
